(19) United States
(12) Patent Application Publication
(10) Pub. No.: US 2017/0246783 A1
(43) Pub. Date: Aug. 31, 2017

(54) SEGMENTED MOLDING CORE SYSTEM OF AN INJECTION MOLD, A METHOD OF INJECTION MOLDING A HOLLOW ARTICLES FORMED THEREBY

(71) Applicant: KETER PLASTIC LTD., Herzeliya (IL)

(72) Inventors: Efraim HAIMOFF, Mevaseret Zion (IL); Arie ASHER, Givaa't Ze'ev (IL)

(73) Assignee: KETER PLASTIC LTD., Herzeliya (IL)

(21) Appl. No.: 15/507,311

(22) PCT Filed: Aug. 27, 2015
(86) PCT No.: PCT/IL2015/050861

§ 371 Date: Feb. 28, 2017

Related U.S. Application Data
(60) Provisional application No. 62/043,438, filed on Aug. 29, 2014.

(51) Int. Cl. B29C 45/44; B29C 45/14; B29C 45/33; B29C 45/26

(52) U.S. Cl. CPC B29C 45/4421; B29C 45/26; B29C 45/14; B29C 45/332; B29C 2045/366

(57) ABSTRACT

Provided is an injection mold and a method of injection molding having a molding core system. The molding core system including a plurality of co-operable components manipulable between a first molding position at which the core system is fully deployed and a second position in which the core system is configured to axially retract and radially contract into a second drawing position, the outer shape of said core system being substantially complementary to the inner shape of the molded article.

### TECHNOLOGICAL FIELD

The disclosed subject matter is directed to a mold and a core element, associated with an injection molding process, and in particular the disclosed subject matter is directed to a dynamic core system, for use in injection molding of articles having a distinct undercut. The disclosed subject matter further pertains to articles having a distinct undercut.

### BACKGROUND

A collapsible core for molding parts is known in the art and is described for example in US2006/0188602, US2009/01152770. US2006/0188602 discloses a two sleeve collapsible core. US2009/01152770 addresses a collapsible core for injection molding of hollow articles that have an internal undercut near opening.

### GENERAL DESCRIPTION

The disclosed subject provides for a dynamic core system for use in molding, e.g. injection molding, and is configured for molding hollow articles having a width of its opening substantially narrower than the articles' largest width extending between the opposite sides of the articles inner surface. The disclosed subject matter is further directed to a mold comprising the dynamic core system. In accordance with the disclosed subject matter, there is further disclosed an injection molded unitary article having a distinct internal undercut.

In accordance with the disclosed subject matter, the core system is assembled of a plurality of co-operable components that function together and are manipulable between a first molding position at which the core is fully deployed and a second position in which the core system is configured to axially retract and radially contract into a second, drawing position. The second drawing position facilitates removal of the injection molded article from the mold in accordance with the disclosed subject matter.

The system in accordance with the disclosed subject matter comprises an axially displaceable core pin and at least one of at least radially displaceable core segments extending around the central core, the outer shape of core system being substantially complementary to the inner shape of the molded article. In accordance with an embodiment of the disclosed subject matter, the system comprises a plurality of core segments. The geometry of the outer shape can vary from a sphere, ellipsoid etc. to any polygonal shape such as a cuboid or more complex shapes having its largest diameter, i.e. the longest distance between two opposite walls defining the inner surface hollow space, substantially wider/longer than that of the opening of the article, e.g. a spherical zone having at least one base such as a ¾ of a sphere or a sector of a sphere.

The core pin in accordance with an embodiment can be a cylinder having a substantially constant radius along its length, between its cap and base. In accordance with the disclosed subject matter, the core pin is at least partially retractable from the core system in a first axial direction, parallel to the central axis of the core system. In accordance with a specific embodiment, the core pin is fully retractable from the core system, such that upon its axial retraction thereof, volumetric space occupied thereby remains void.

The term “volumetric space” as defined herein refers to the space bounded by the outer perimeter of the core pin. The circumference of the volumetric space substantially corresponds in its dimensions to the outer circumferential shape of the core pin. In accordance with an embodiment, the core pin can have a circular cross section e.g. its volumetric space is that of an inscribing cylinder of the core in case of a substantially cylindrical shape and in a cross section it is the circumcircle which passes through all the vertices of the core pin. In accordance with an embodiment of the disclosed subject matter the radius of the circumcircle remaining substantially constant along the height of the core pin, such that the radius of the cylinder circumferencing (circum-cylinder) the core pin has a substantially constant diameter. Alternatively, the core pin can have any polygonal shape and the volumetric space defined thereby will be that defined by its general circumference.

In accordance with an embodiment of the disclosed subject matter, two or more of at least radially displaceable core segments extending around the central core comprise at least one group of dynamic segment member(s) configured for radial displacement towards the central axis of the core system. In accordance with the disclosed subject matter, the number of groups can vary from 1 to n as long as the total volumetric space of at least n minus 1 group when radially displaced towards the central axis of the core system does not exceed the volumetric space of the core pin, e.g. the space defined by its outer perimeter, when axially retracted. Each group can comprise any number of segments, as long as the above special relationship is maintained. It will be appreciated that the larger the ratio of diameter of the core pin to the largest diameter of the core system, the larger is the number of groups of dynamic segments that can be received within the space.

In accordance with an embodiment of the disclosed subject matter, at least one of the groups of the dynamic segment members can be further axially displaced in a direction opposite the axial direction of the core pin translation in the first axial direction.

In accordance with a specific embodiment of the disclosed subject matter, the core segments comprise a first group of dynamic segment members and a second group of dynamic segment members, all substantially circumferentially extending around the core pin. The outer surface of the core system, substantially conforming to the inner surface of the hollow article cavity. In accordance with this example, the first group of segment members are configured for radially translating in a direction towards the central axis of the core system, while the second group of dynamic segment members is configured for radially translating in a direction towards the central axis of the core system and further to axially translate in a direction opposite the direction of the retraction of the core pin. In accordance with an embodiment of the disclosed subject matter, the radial translation towards the axis and the axial translation of the second group can be performed substantially concurrently, i.e. in a combined motion. The movements of both groups can be provided concurrently, however the first group will be moved faster than the second group.

The number of groups of segment members can be more than one, as indicated hereinabove. In accordance with an embodiment of the disclosed subject matter the larger the number of segment members and/or groups comprising these, the smaller the diameter of the opening of the article that can be formed using the system of the disclosed subject matter. This is due to the design of the core system, e.g. the pin and the core segments that are such that, when the pin is retracted in a first direction along a central axis of the core system and the core pin, the core segments remain stationary relative to the translation of the core pin, the core pin is fully retracted, leaving the space occupied thereby void. The first group of secondary segments is allowed to radially translate in a direction towards the central axis. In accordance with the disclosed subject matter, the group can comprise any number of members from 1 to m, however, the total space occupied by segment(s) does not substantially exceed the volumetric space previously occupied by the core pin.

The second group of dynamic segment members in accordance with the disclosed subject matter radially moves generally in the direction of the central axis and concurrently translates axially in the second direction opposite to the first axial direction of the core pin, to extend substantially above the first group of the dynamic segment members. Thus allowing the article to be removed from the mold.

In accordance with one embodiment of the disclosed subject matter, the core pin and the core segments, form together a sphere segment having one base (e.g. ¾ of a sphere). In accordance with an embodiment, the core pin is cylindrical and the secondary core segments are segments of a spherical ring, such that the central axis of the core and the sphere coincide. The core pin can be configured with a spherical end at its cap portion and have a substantially constant radius along the majority of its length. The core segments extend circumferentially around the core.

In operation of the core system, the core pin is retracted in a first axial direction along a central axis of the core pin, the core segments remain stationary relative to the translation of the core pin, the core pin is substantially fully retracted, leaving the space occupied thereby void. The core segments are then allowed to radially translate in a direction toward the central axis of the void space, such that at least some of the dynamic segment members are translated into the void space. This radial translation facilitates contraction of the core system, and thus removal of the molded article. In accordance with an embodiment of the disclosed subject matter, the at least one of the core segments is translated radially towards the central axis of the void space and further translated axially in a direction opposite the first direction. This radial and axial translations can be performed simultaneously or sequentially (e.g. inward and lengthwise movement), e.g. radial contraction of the core system followed by an axial translation of the second group.

In operation, this allows removing the injection molded hollow article away from the mold and removing it from the molding core system. The result of the radial contraction is that the largest diameter of the core assembly of the invention is substantially shrunk and collapsed and the article can be easily removed therefrom.

The number of alternately extending segment members in each group can be more than two.

The core pin radius may vary, such that the core pin has taper or uneven sidewalls. The core pin cap can have any desired geometry to conform to the desired shape of the article. In accordance with one example, the cap is rounded to conform to the semi spherical shape of the core system. In accordance with another example, the cap can have a flat end. The surface of the cap or the segments can be provided with corrugations, e.g. to form aesthetic effects of the final article.

The sidewalls of the core pin can be substantially smooth or can alternatively comprise grooves thereon to engage with components of the system, e.g. the secondary core segments, the retraction mechanism, etc.

The device also includes a base member having a plurality of engaging members, such as grooves, for engaging at least some of the core segments.

The core segments can each have an engaging member, such as a rail or a protrusion, that engages with a respective engaging member of the base member. The engaging members of the core segments and the engaging members of the base member are configured to allow the core segment members to translate both radially and axially.

In accordance with another embodiment of the disclosed subject matter there is provided an injection mold comprising a segmented mold base having a mold cavity corresponding to an outer shape of at least part of the molded article and a mold cover having a cavity corresponding to the remainder of the outer shape of the article. The segmented mold base comprises radially slidable mold segments. The mold further comprises a core system in accordance with the disclosed subject matter, comprising a plurality of co-operable components manipulable between a first molding position at which the core system is fully deployed and a second position in which the core system is configured to progressively axially retract and radially contract into a second retracted position, the outer shape of core system being substantially complementary to the inner shape of the molded article.

An injection mold in accordance with an embodiment of the disclosed subject matter comprising a segmented mold base having a mold cavity corresponding to an outer shape of at least part of the molded article and a mold cover having a cavity corresponding to the remainder of the outer shape of the article, the segmented mold base comprising radially slidable mold segments. The mold further comprising a core system comprising an axially displaceable core pin and a plurality of at least radially displaceable core segments extending around the core pin, the outer shape of core system being substantially complementary to the inner shape of the molded article.

In accordance with an embodiment of the disclosed subject matter the injection mold being operable in a first, injecting position, in which the core system is in a fully deployed configuration and the mold sliding segments form together a continuous inner surface of the mold cavity and a second position, in which the mold sliding segments are radially displaced and spaced apart and the core system is configured to progressively axially retract and radially contract into a second retracted position.

In accordance with yet an aspect of the disclosed subject matter, there is disclosed a method of injection molding a substantially hollow article having at least one opening substantially narrower than the articles largest width, comprising:

providing a mold comprising a mold base, a mold cover, wherein the cavity extending within the mold base and the cover correspond to the outer surface of the article and a dynamic core system having a central longitudinal axis extending therethrough, the core system comprising at least an axially displacable core pin and at least one radially displaceable core segment, wherein the outer surface of the core system corresponds to the inner surface of the article;

injecting a molten material into the mold wherein the core system is at its first operable position in which the core system is in a fully deployed position, where the mold cover is covering the mold base with the core system extending therebetween, such that the outer surface of the core system substantially corresponds to the inner surface of the hollow article and wherein mold cavity is defined by circumferentially extending mold cavity on the mold base and the mold cover;

releasing the mold cover from the mold base;

translating the core system into a second position, in which the core system is configured to axially retract and radially contract into a second drawing position; and

removing the article from the mold.

In accordance with an embodiment, in the second position, the core pin is axially displaced substantially retracting from the hollow cavity of the article and at least one of the at least one core segments is radially displaced towards the central axis.

This general description has been provided so that the nature of the disclosed subject matter can be generally understood without being limited to a specific example A more complete understanding of the invention can be obtained by reference to the following detailed description of the examples thereof in connection with the attached drawings.

### BRIEF DESCRIPTION OF THE DRAWINGS

In order to better understand the subject matter that is disclosed herein and to exemplify how it may be carried out in practice, embodiments will now be described, by way of non-limiting examples only, with reference to the accompanying drawings, in which:

FIG. 1 is a top perspective view of an injection molded article formed using an injection mold in accordance with an example of the disclosed subject matter;

FIG. 2 is a top perspective view of an injection mold assembly in accordance with the disclosed subject matter, in a first operative position;

FIG. 3 is a cross section of the assembly of FIG. 2, taken along the line C-C;

FIG. 4 is a top perspective view of an injection assembly in accordance with the disclosed subject matter, with the cover mold part removed from the mold base part;

FIG. 5 is a top perspective view of the mold base part, with the article retained therein and in a first operative position;

FIG. 6A is a top perspective view of the mold base part of FIG. 5, with the article not shown;

FIG. 6B is a bottom perspective view of the assembly of FIG. 4, showing the cavity of the mold cover part;

FIGS. 7A and 7B illustrate a top plan view of the mold base part with the mold sliding members in a first position and a second, radially translated position, respectively;

FIG. 8A is a side cross sectional view of the mold base part on FIG. 7B;

FIG. 8B illustrates a base part of FIG. 8A, with the core system supporting slides, radially retracted;

FIG. 8C illustrates the base part of FIG. 8B with the core pin in a retracted position;

FIGS. 9A and 9B illustrate the core system in a side view with the mold base parts removed, in a first, fully deployed position and with a core pin in a retracted position;

FIG. 10 is a top perspective view of the base mold of FIG. 8C;

FIG. 11 illustrates the base mold of FIG. 10, with a first portion of the core segments, radially translated towards the central axis of the core system;

FIG. 12A is a top perspective view of the base mold of FIG. 11 with the second portion of core segments radially translated towards the central axis of the core system and further axially translated to extend above the first portion of the core segments;

FIG. 12B is similar to FIG. 12A, however with the base mold part sliding members and the core system translating members removed; and

FIG. 12C illustrates the transition of the second portion of the core segments from their first, fully deployed position as seen in FIG. 11 to the position of FIG. 12B, with the article presented thereon.

### DETAILED DESCRIPTION OF EMBODIMENTS

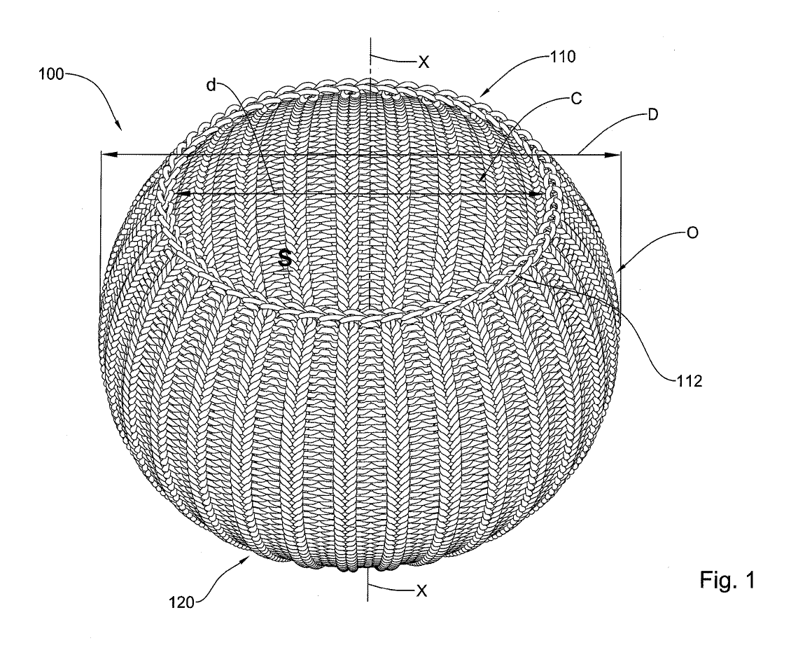

Attention is first directed to FIG. 1, illustrating an injection molded hollow article generally designated 100 in accordance with an example of the disclosed subject matter, the article having a longitudinal axis X. The article 100 is a hollow semi-sphere, having a top side 110 and a bottom side 120, having a cavity C defined by an inner wall surface S, and further having an outer surface O. The article 100 comprises a sphere base at its top side 110 extending at the plane of the article rim 112 and defining an opening of the cavity C. The largest diameter of the article between the two opposite sides of the inner wall surface is denoted D and the diameter of the cavity opening is marked d. The relation between the diameters is D>d. as can be seen in the illustration, the undercut of the molded article is distinct and in this example the diameter ration is about 2:3. It will be appreciated that other ratios are also envisioned by the teachings of the disclosed subject matter. It will be further appreciated that while the present example illustrates a semi sphere, other sphere sectors can be molded in accordance with the disclosed subject matter with one or more openings and other geometrical shapes being further envisioned as part of the disclosed subject matter, e.g. a substantially hollow ellipsoid, a hollow polygon, a hollow cube having an opening at one of its faces, the width of the opening being narrower than that of the widest portion of the cavity of the article, i.e. having a substantially distinct undercut.

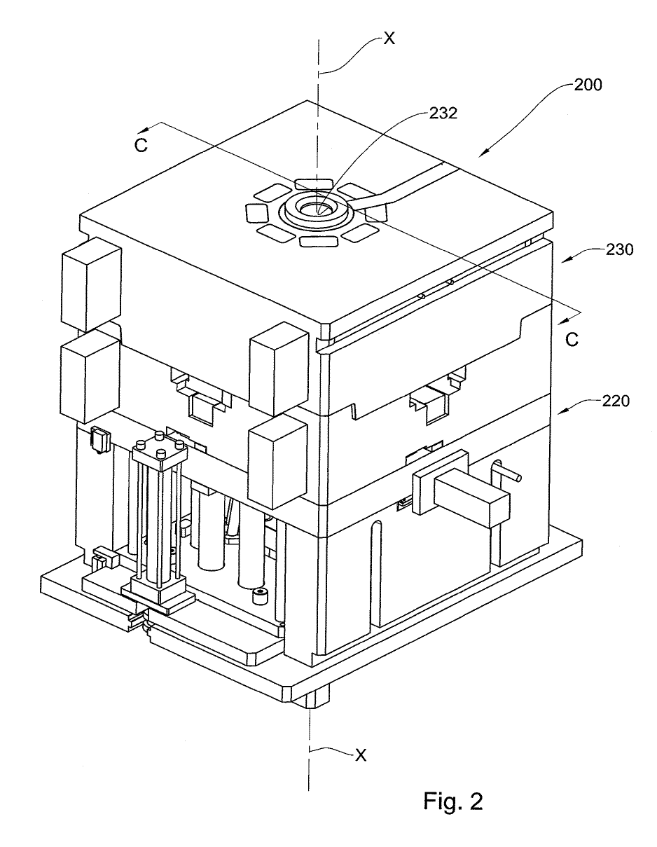

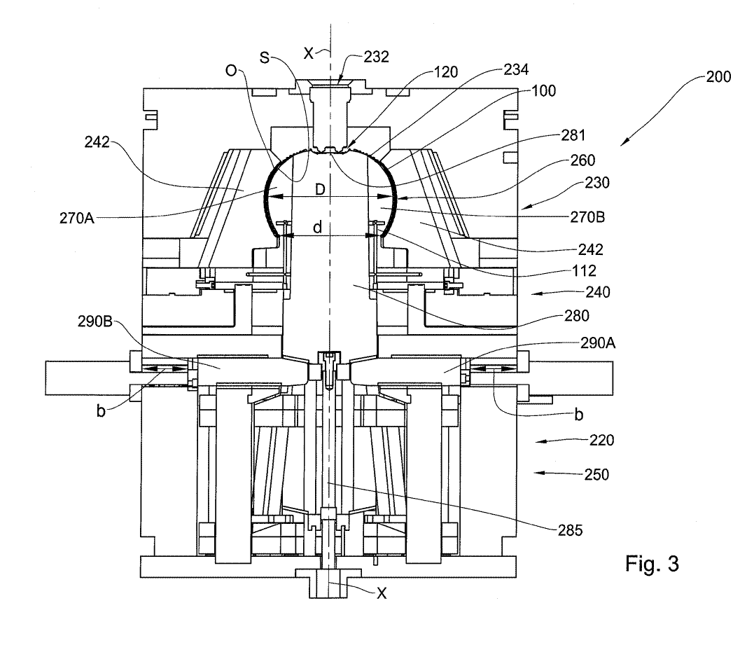

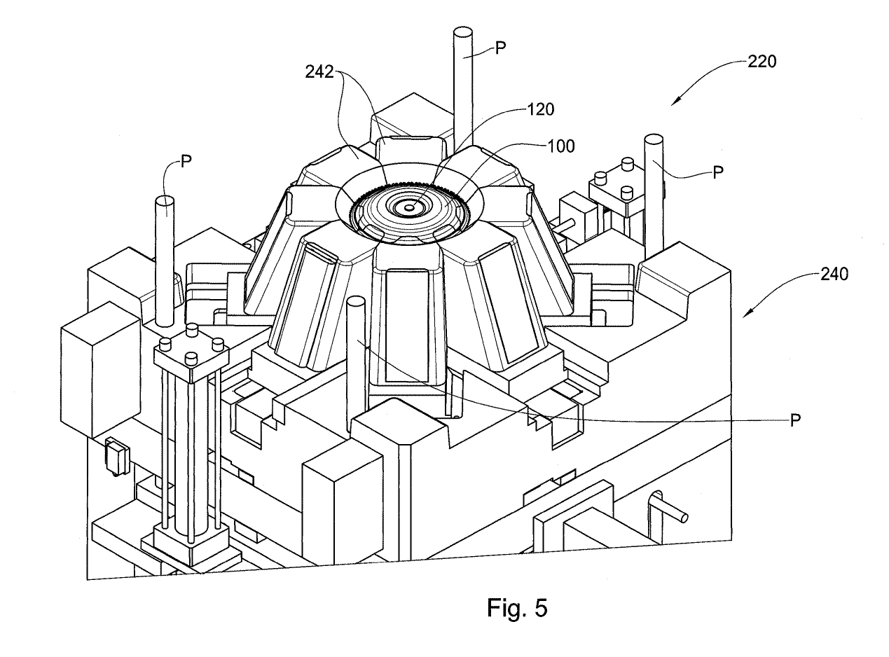

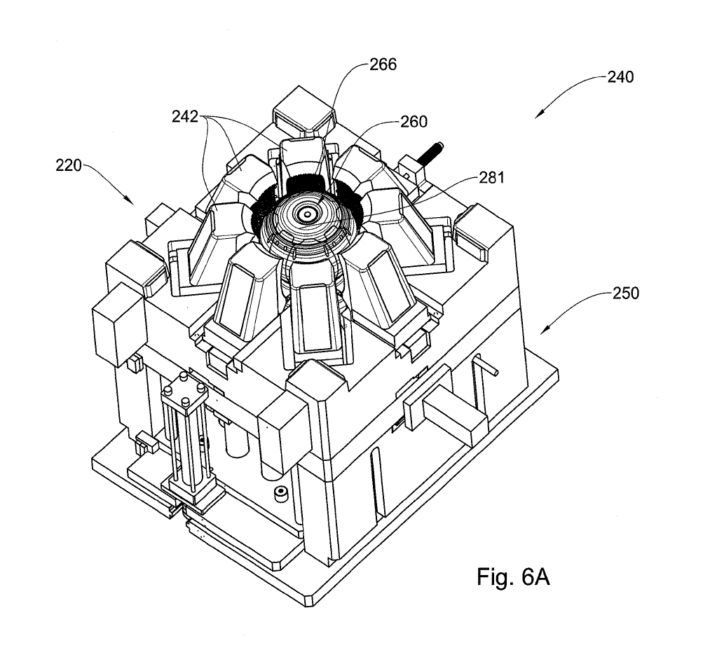

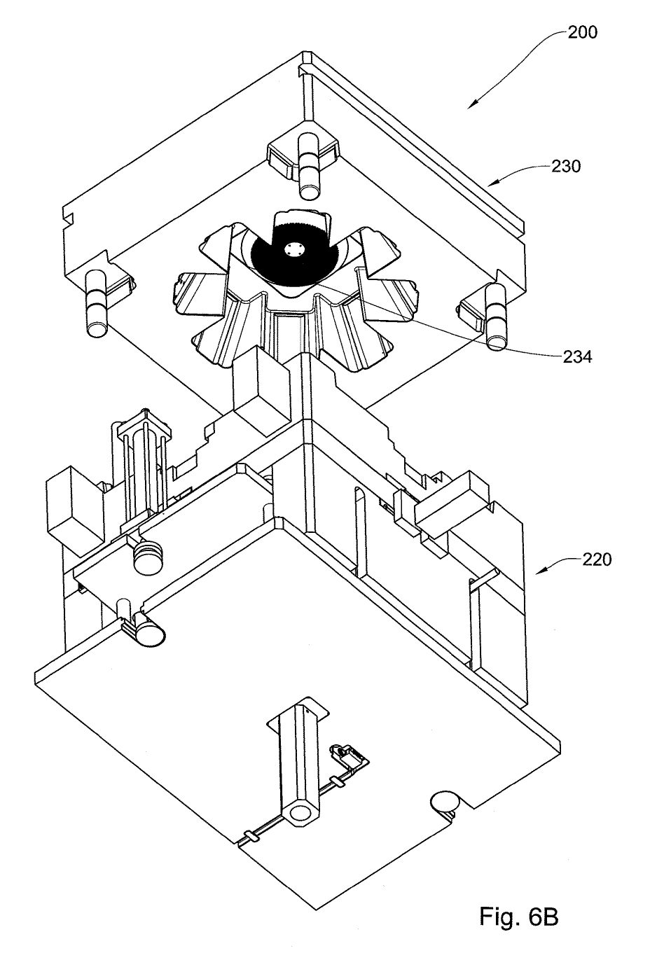

FIGS. 2 and 3 illustrate the injection mold generally designated 200 in accordance with an example of the disclosed subject matter. The injection mold 200 comprises a mold base 220 and a mold cover 230, with the injection port 232 extending substantially at the center of the cover 230. The mold cover 230 comprises a cavity 234 corresponding to the shape of the bottom portion 120 of the outer surface O of the injected article 100, and can be seen best in FIG. 6B. The mold base and the mold cover are engageable via lock pins P extending from the base mold (seen in FIG. 5). FIGS. 2 and 3 illustrate the injection mold in its first operational position, during which the article 100 is injected (article seen as a thin dark line extending over the core system from its one side and enclosed by the mold base cavity and the mold cover cavity from its outer surface in FIG. 3, thus defining the outer surface thereof).

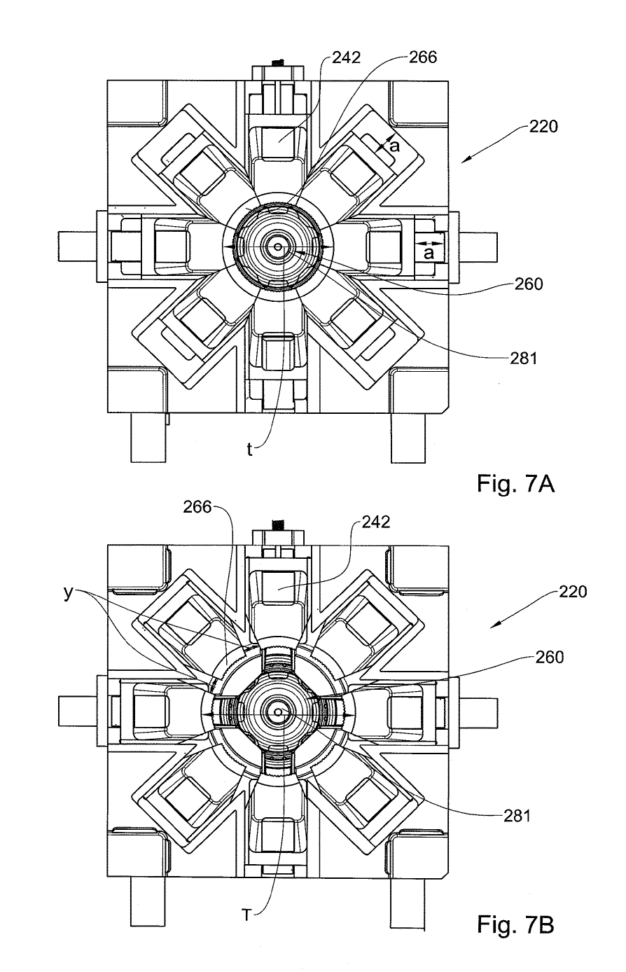

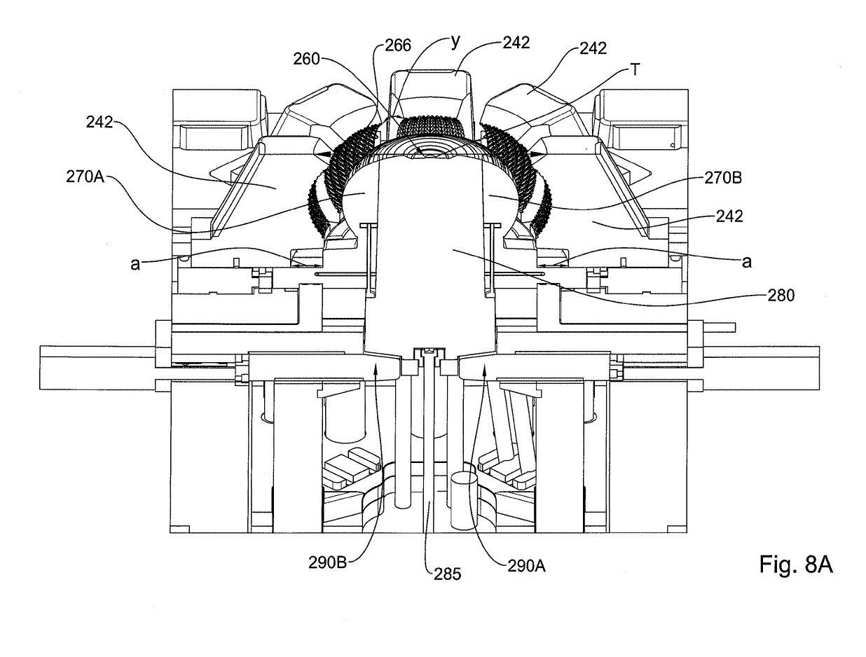

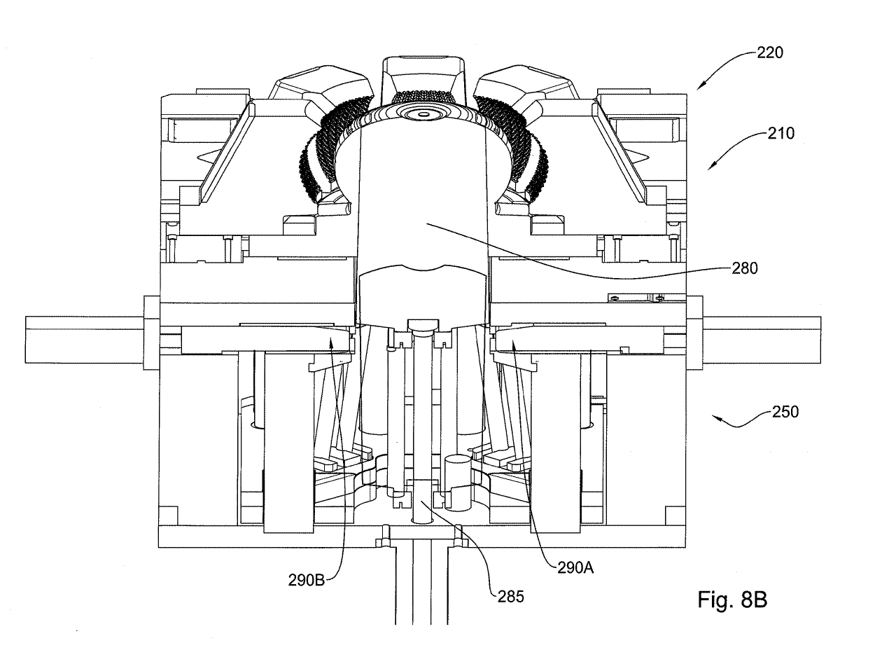

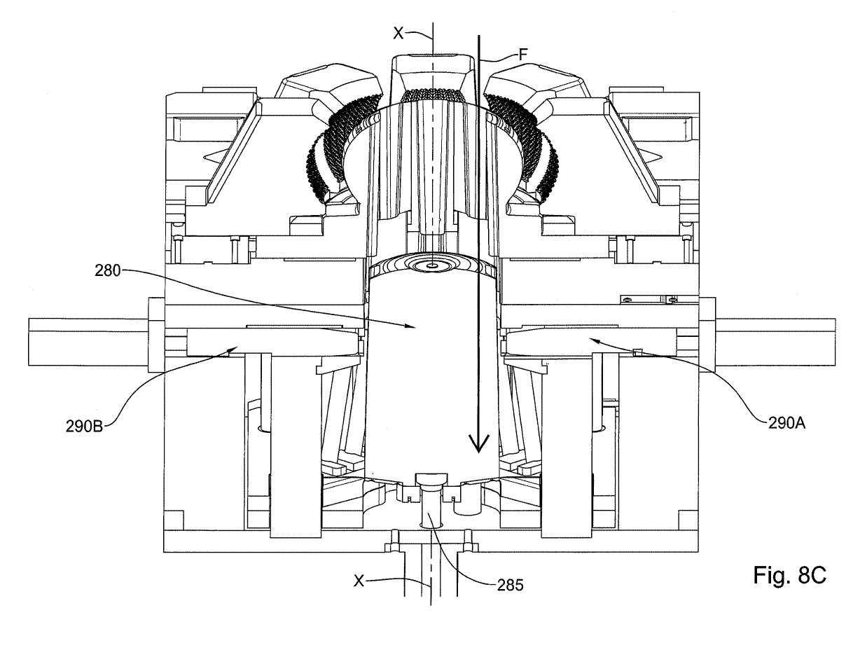

The mold base 220 comprises a top portion 240 (best seen in FIGS. 6A and 7A and 7B) and a bottom portion 250 (also seen in FIG. 8B). The top portion of the base mold comprises a plurality of radially sliding mold segments 242, seen in FIG. 3 in their first position in which the sliding mold segments 242 form together a cavity 260 (seen in FIG. 7A) corresponding to the outer surface of the article 100 and in this example further complimenting the cavity 234 of the cover mold 230. As the article 100 has a curved outer side, it can be seen that the inner surface of the sliding mold segments are concave/arched to conform to the convex shape of the outer wall O of the article 100. The sliding mold segments 242 are configured for sliding radially with respect to the central axis X of the mold as indicated by the arrows “a”, and are further seen in their first operating position in FIG. 7A and in the second operation position in FIGS. 7B and 8A, where the mold segments 242 are displaced away from the axis X.

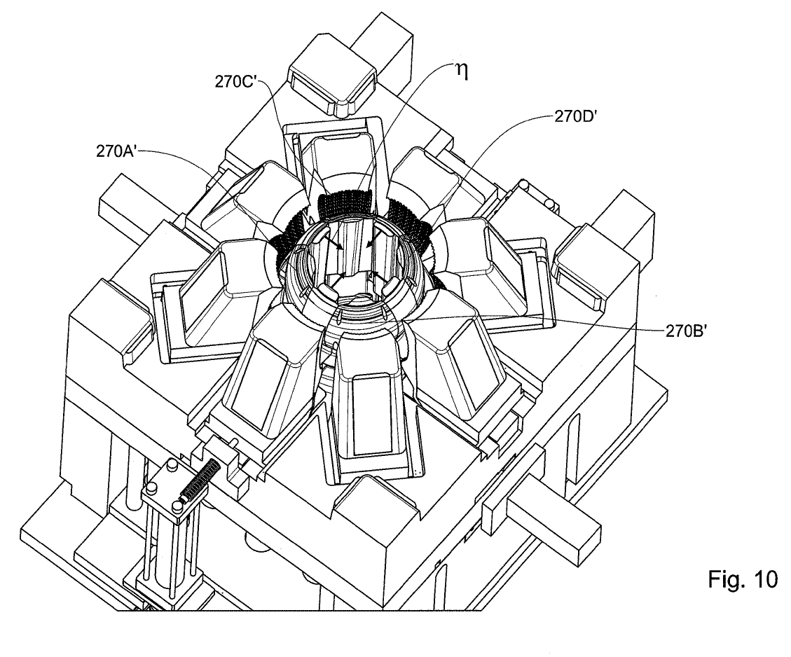

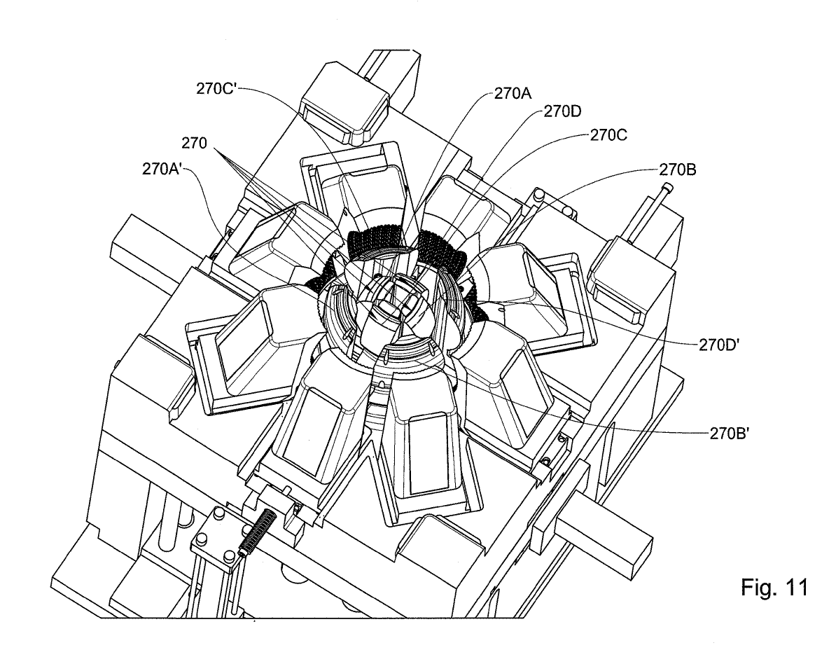

The central portion of the base mold 220 comprises a dynamic core system 260 comprising a core pin 280 and a plurality of core segments 270 (only two seen in cross section of FIG. 3, designated 270A and 270B, while the system comprises eight core segments, as seen in FIGS. 10A and 11) extending around the core pin 280. The outer surface of the core system corresponds to the inner shape and the inner surface S of the articles' hollow cavity. In accordance with this example, the widest diameter D of the hollow space of the article 100 corresponds and is substantially defined by the widest diameter of the core system and the diameter d of the opening is substantially defined by the core system diameter at the corresponding location. In this example the central axis of the core system 260 co-extends with the central longitudinal axis X of the mold 200.

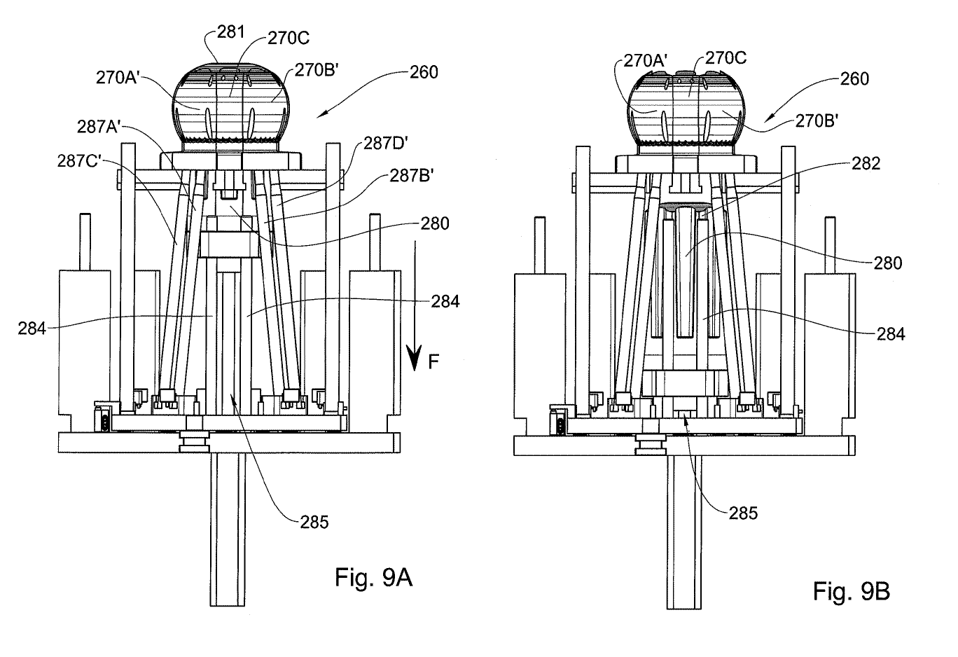

The core pin 280 is supported by a longitudinally extending support member 285, further configured for axial displacement of the core pin. The core pin 280 is further provided with lateral grooves 282 extending on its surface (best seen in FIGS. 9A and 9B), the grooves 282 being configured to engage laterally extending supports 284 extending at the bottom portion of the base mold for maintaining the position of the core pin 280 when in the axially retracted configuration, as will be discussed hereinbelow. It will be appreciated that the grooves over the core pin are optional and in accordance with examples of the disclosed subject matter the core pin can be smooth. The top end 281 of the core pin 280 corresponds in this example to the bottom side of the article's 100 inner cavity C. It will be appreciated, that the shape of the top end 281 of the core pin can vary to have any desired shape.

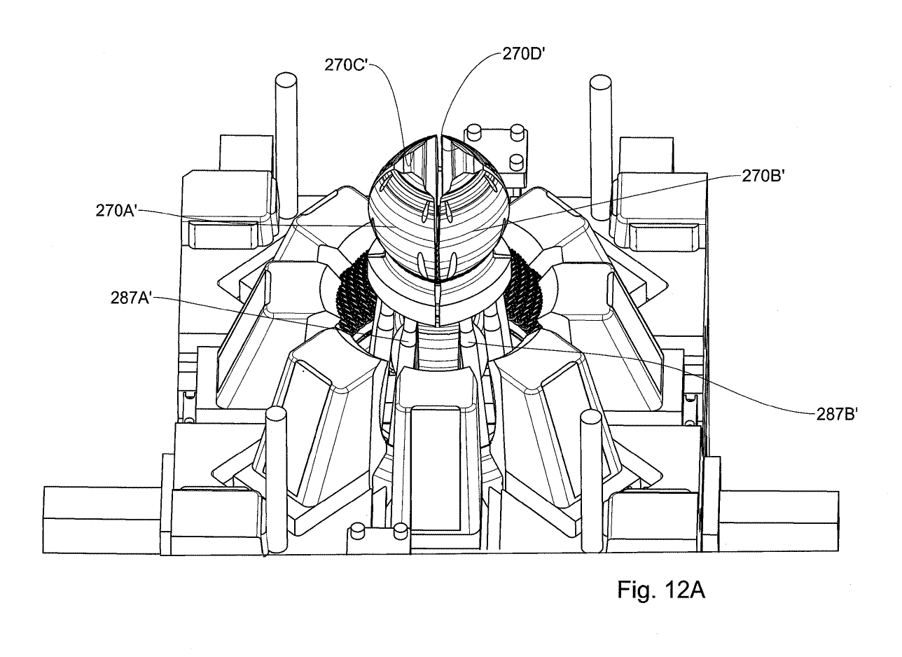

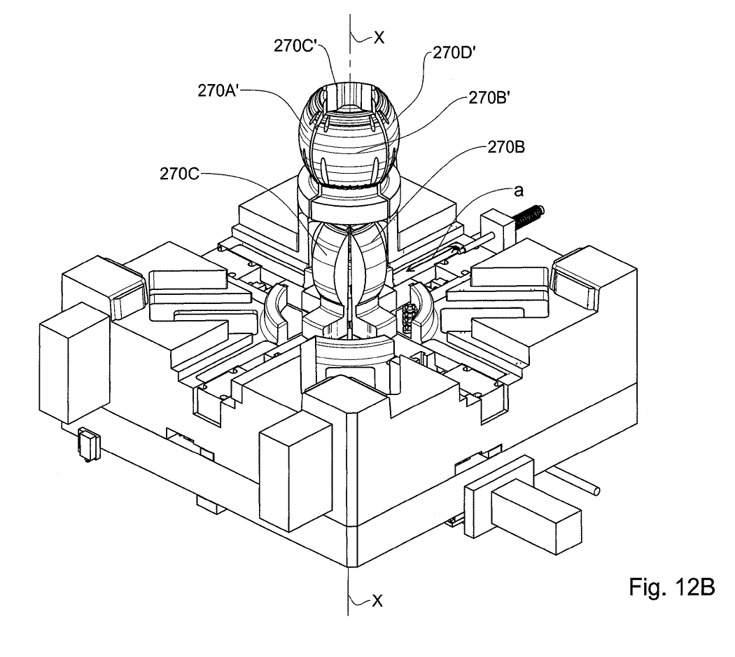

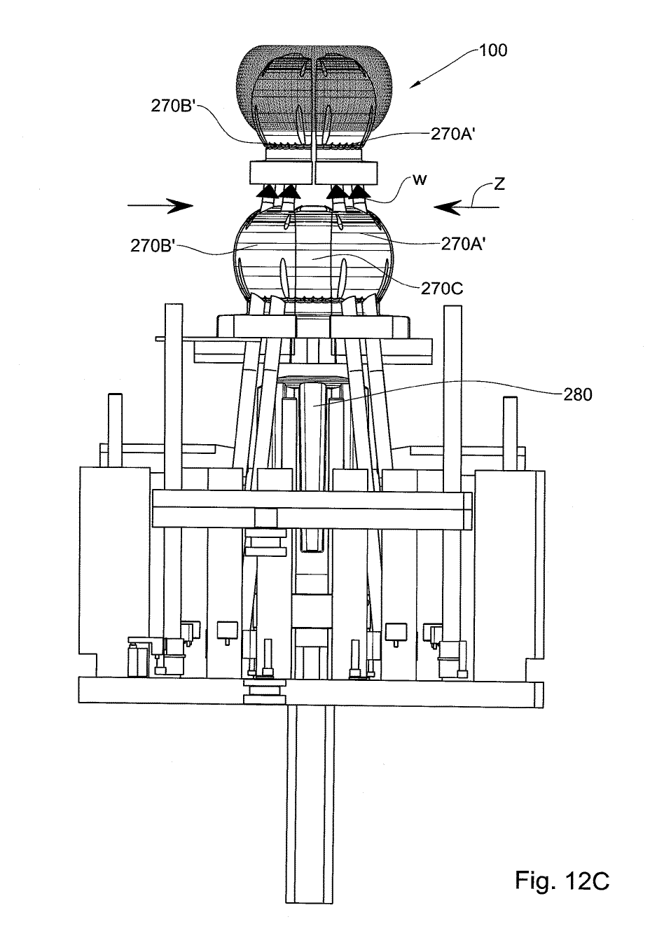

The core segments 270 are at least radially displaceable and in the present example comprise two groups of alternating segments, each group comprising four segments, best seen in FIGS. 11 and 12A. In the illustrated example both groups are configured for radial displacement and one of the groups is further configured for axial displacement along the axis X. To substantially fully engage the core pin 280 in the first, fully deployed configuration, the core segments are provided with engaging members (not seen) configured to engage the core pin, e.g. through the grooves 282. It will be appreciated that the segments can be devoid of any such engaging members. The first group of the core segments 270 comprises four radially translatable segments 270A, 270B, 270C and 270D. These segments are configured to radially translate on the top surface of the mold base in the direction substantially perpendicular to the central axis X. The four segments 270A′, 270B′, 270C′ and 270D′ of the second group (best seen e.g. in FIGS. 9A and 9B and in 12A) are each supported over a translating member 287A, 287B, 287C and 287D, respectively. The translating members 287 are configured to translate the core segments 270′ radially and axially, as will be further discussed. It will be appreciated that the core segment can comprise any number of segments (1+n), with the segments being configured for radial displacement and further optional axial displacement of one or more of the segments.

The bottom portion of the mold base, comprises circumferentially extending support sliders 290A and 290B (in the current example two, although any other configuration of such slides can be utilized provided they perform similar function). The support slides are configured for extending under at least a portion of the core pin 280, preventing unintentional displacement thereof, and are further configured to be slidably displaced along the arrow “b” to allow the core pin 280 to axially retract via the support member 285 towards the bottom portion 250 of the mold base. The axial direction of retraction is parallel with the central axis X.

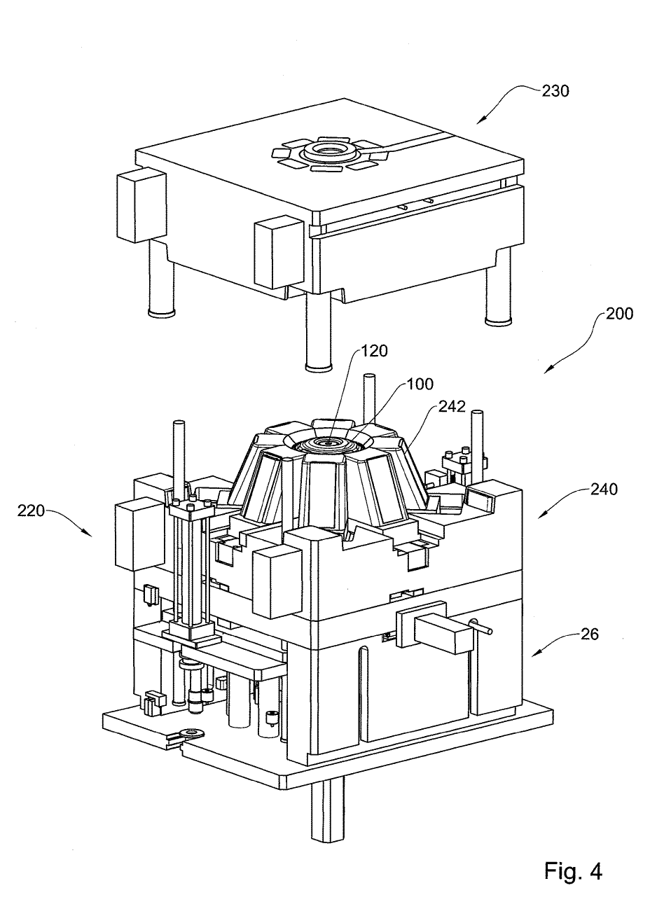

In operation, the molten material, e.g. plastic, is injected into the mold through the port 232 (in accordance with the invention the number of ports can vary) with the mold in a first operable position as seen in FIG. 3, and with the mold cover being connected to the mold base. In this first operable position, the dynamic core system is in its first, fully deployed position, where the core pin fully extends within the mold cavity with the core segments extending therearound. The core pin is supported and held in this position by the sliders 290 and the retractable support member 285. The mold segments 242 extend to form a cavity together with the cavity of the cover mold conforming to the outer shape of the injected article. When the molten material is fully injected, the mold cover is removed from the base mold, as seen in FIG. 4. To release the article from the mold, the diameter t between the mold sliding segments is increased sufficiently to the largest diameter T conforming that of the article to pass through the edge of the mold cavity constituted by the mold segments (as seen in FIG. 5 and in FIG. 7B illustrating this broadening without the article). The diameter t is increased by spacing the edges of the slide members, the spacing denoted by y in FIG. 7B. As the article is hollow having a diameter D between opposite points of the inner surface S thereof substantially wider than that of the article's opening d, i.e. having a distinct undercut, the article cannot be removed at this stage. To facilitate the release of the article, the core system is actuated into a second drawing position.

FIGS. 8A to 12A sequentially illustrate the stages of core system actuation in accordance with an example of the disclosed subject matter. To facilitate retraction of the core pin 280, the sliders 290A and 290B are radially translated away from the core pin (FIG. 8B), the core pin support member 285 is retracted, axially transporting the core pin 280 away from the core system 260 and into the bottom portion 250 of the mold base 240 in the direction of arrow F, parallel to the central axis X, as seen in FIGS. 8C and 9B (it should be noted that the mold base in FIGS. 9A and 9B was stripped of parts of the mold for ease of visualization of the core system). As the core pin 280 is retracted, the space occupied thereby is now void, as further seen in FIG. 10A. To translate the remainder of the core system 260 into the draw position, the first group of core segments is radially translated towards the central axis as illustrated by the arrows z in FIG. 10A, until the core segments of this group 270 are in contact with each other as seen in FIG. 11. At this stage, the article is still maintained in its first position by the second group of core segments 270′ (article not shown). The second group of core segments 270′ is in accordance with this example translated simultaneously radially towards the central axis and further axially to elevate the second group of core segments above the first group 270 (best seen in FIG. 12B in which the base mold was stripped of some of its part for ease of demonstration). This movement is achieved through the motion of the radially slidable support pistons (e.g. pneumatic pistons) which translate the segments radially and concurrently axially move over the first group of segments 270. This translation of the second group 270′, narrows the width of the core segments 270′ and thus of the core system 260, to a width equal to or narrower than that of the opening, so as to facilitate the removal of the article from the mold. FIG. 12C illustrates sequentially the stages of translation of the second group 270′ of core segments in the direction of arrows W, which are in opposite direction to arrows, discussed above.

While the disclosed subject matter, and in particular the core system have been discussed and illustrated with respect to injection molding, and many details thereof have been presented for the purposes of illustration, it will be apparent to those skilled in the art that the disclosed subject matter is susceptible to additional variations and certain details described can vary without departing from the basic principles of the disclosed subject matter. It will also be appreciated by those skilled in the art, that the dynamic core system can be used not only with injection molding, but also with die casting, blow molding, rotor molding and other similar molding processes, requiring the molded material to take shape within a mold and around a mold/core. The mold and the core system can be conformed to the process, mutatis mutandis, without departing from the principles of the disclosed subject matter.

1. A molding core system comprising a plurality of co-operable components manipulable between a first molding position at which the core system is fully deployed and a second position in which the core system is configured to axially retract and radially contract into a second drawing position, the outer shape of said core system being substantially complementary to the inner shape of the molded article.

2. A molding core system comprising a plurality of co-operable components manipulable between a first molding position at which the core system is fully deployed and a second position in which the core system is configured to axially retract and radially contract into a second drawing position, wherein said core system comprises an axially displaceable core pin and at least one of at least radially displaceable core segments extending around the core pin, the outer shape of core system being substantially complementary to the inner shape of the molded article.

3. The molding core system of claim 2, wherein the core pin is displaceable in a first axial direction and at least one of the core segments is further configured for axial displacement in an opposite, second axial direction.

4. The molding core system of claim 2, wherein the at least one of the core segments is simultaneously displaced radially and axially in the second axial direction.

5. The molding core system of claim 2, wherein the system comprises a plurality of core segments.

6. The molding core system of claim 2, wherein the geometry of the outer shape has its largest diameter, substantially wider/longer than that of the opening of the article.

7. The molding core system of claim 2, wherein the core pin has a substantially constant radius along its length, between its cap and base.

8. The molding core system of claim 2, wherein the core pin is at least partially retractable from the core system in a first axial direction, parallel to the central axis of the core system.

9. The molding core system of claim 2, wherein the core pin is fully retractable from the core system, such that upon its axial retraction thereof, volumetric space occupied thereby remains void.

10. The molding core system of claim 2, wherein two or more of at least radially displaceable core segments extending around the central core comprise at least one group of dynamic segment members configured for radial displacement towards the central axis of the core system.

11. The molding core system of claim 10, wherein the number of groups can vary from 1 to n as long as the total volumetric space of at least n minus 1 group when radially displaced towards the central axis of the core system does not exceed the volumetric space of the core pin when axially retracted and wherein each group can comprise any number of segments maintaining the spatial relationship

12. The molding core system of claim 10, wherein at least one of the groups of the dynamic segment members is axially displacable in a direction opposite the axial direction of the core pin translation in the first axial direction.

13. The molding core system of claim 1, wherein the core segments comprise a first group of dynamic segment members and a second group of dynamic segment members, all substantially circumferentially extending around the core pin, wherein the outer surface of the core system, substantially conforming to the inner surface of the hollow article cavity and the first group of segment members are configured for radially translating in a direction towards the central axis of the core system, while the second group of dynamic segment members is configured for radially translating in a direction towards the central axis of the core system and further to axially translate in a direction opposite the direction of the retraction of the core pin.

14. The molding core system of claim 13, wherein the radial translation towards the axis and the axial translation of the second group is performed substantially concurrently in a combined motion where the first group moves faster than the second group.

15. The molding core system of claim 1, wherein the core pin and the core segments, form together a sphere segment having one base such that the core pin is cylindrical and the secondary core segments are segments of a spherical ring and extend circumferentially around the core pin, such that the central axis of the core and the sphere coincide.

16. An injection mold comprising a segmented mold base having a mold cavity corresponding to an outer shape of at least part of the molded article and a mold cover having a cavity corresponding to the remainder of the outer shape of the article, the segmented mold base comprising radially slidable mold segments, the mold further comprising a core system comprising a plurality of co-operable components manipulable between a first molding position at which the core system is fully deployed and a second position in which the core system is configured to axially retract and radially contract into a second drawing position, the outer shape of core system being substantially complementary to the inner shape of the molded article.

17. An injection mold comprising a segmented mold base having a mold cavity corresponding to an outer shape of at least part of the molded article and a mold cover having a cavity corresponding to the remainder of the outer shape of the article, the segmented mold base comprising radially slidable mold segments, the mold further comprises a core system comprising an axially displaceable core pin and at least one of at least radially displaceable core segments extending around the core pin, the outer shape of the core system being substantially complementary to the inner shape of the molded article.

18. The injection mold of claim 16 wherein, the injection mold being operable in a first, injecting position, in which the core system is in a fully deployed configuration and the mold sliding segments form together a continuous inner surface of the mold cavity and a second position, in which the mold sliding segments are displaced radially and spaced apart and the core system is configured to progressively axially retract and radially contract into a second retracted position.

19. (canceled)

20. A method of injection molding a substantially hollow article having at least one opening substantially narrower than the articles largest width, comprising:
providing a mold comprising a mold base, a mold cover, wherein the cavity extending within the mold base and the cover correspond to the outer surface of the article and a dynamic core system having a central longitudinal axis extending therethrough, the core system comprising at least an axially displacable core pin and at least one radially displaceable core segment, wherein the outer surface of the core system corresponds to the inner surface of the article;
injecting a molten material into the mold wherein the core system is at its first operable position in which the core system is in a fully deployed position, where the mold cover is covering the mold base with the core system extending therebetween;
releasing the cover of the mold base;
translating the core system into a second position, in which the core system is configured to axially retract and radially contract into a second drawing position; and
removing the article from the mold.

21. The method of injection molding of claim 20, wherein in the second position, the core pin is displaced axially substantially retracting from the hollow cavity of the article and at least one of the at least one core segments is radially displaced towards the central axis.
